(19) United States
(12) Patent Application Publication
(10) Pub. No.: US 2006/0027229 A1
(43) Pub. Date: Feb. 9, 2006

(54) Portable smoker

(76) Inventor: James S. Bass, Fort Myers, FL (US)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/911,540

(22) Filed: Aug. 5, 2004

(51) Int. Cl. A47J 33/00

(52) U.S. Cl. 126/25 R

(57) ABSTRACT

Disclosed is a smoker device which is effective in imparting a smoky flavor to food as it cooks and is also conveniently portable. The device includes two pairs of opposing vertical panels, each panel having substantially rectangular shape and having four substantially straight edges, and an attachment mechanism located on at least one straight edge of each vertical panel for attaching that side edge to a side edge of an adjacent vertical panel. The two pairs of vertical panels cooperate with hot coals or another heat source, when in operation to form a platform having four top edges and to smoke food. The first pair of vertical panels and the second pair of vertical panels are capable of being folded into a substantially planar shape. A lid covers the top edges of the platform. An adjustable vent is located on the surface of the cover, which in its open position permits maximum smoke to exit the smoker device and in its closed position substantially blocks smoke from exiting the smoker device. A structure for supporting food during the cooking operation, such as an array of spaced-apart bars, is secured the array to the inner sides of the first pair of opposing vertical panels and supports food to be cooked.

### TECHNICAL FIELD

The present invention relates generally to a smoker device which may be used in a cooking operation to impart a smoky flavor to food as it is cooked, and more specifically to a portable smoker device which is easily carried, for instance by campers, hikers, and back-packers. The degree to which a smoky flavor is imparted to the food may be regulated as desired by an adjustable vent.

### BACKGROUND OF THE INVENTION

A barbeque smoker housing having an interior provided with food holders therein, is disclosed in U.S. Pat. No. 4,643,162. A bottom portion of the housing having a perforated wall which admits combustion air there beyond, and a heat source, and a control for altering the rate at which the food cooks disposed at upper and lower portions of the housing.

A barbeque cooking and smoking apparatus is disclosed in U.S. Pat. No. 4,664,026, having a separate oven and an adjacent firebox with a smoke passage opening between the firebox and oven for passage of smoke and heat from the firebox into the oven having a positive mechanical gate operated by the oven door which blocks the smoke passage opening when the oven door is open and opens the smoke passage opening when the oven door is closed.

A combustion apparatus is disclosed in U.S. Pat. No. 4,825,845 for burning wood or coal comprises a cooking enclosure mounted above a combustion chamber enclosure. An upper space of the combustion chamber enclosure contains a combustion chamber having a floor and walls made of refractory material. The combustion chamber is closed all around except for the top. A plurality of primary air holes are provided in the floor of the combustion chamber and a plurality of secondary air holes are provided through the combustion chamber enclosure at the level of the open top of the combustion chamber. An ash pan is mounted for sliding into the combustion chamber enclosure below the combustion chamber to act as a regulator for air entering the combustion chamber enclosure. A cooking plate is pivotally mounted in the cooking enclosure so that it can be lowered into a cooking position over the open top of the combustion chamber. Exhaust gases from the combustion chamber leave the chamber through a space between a rear edge of the lowered cooking plate and a rear wall of the cooking enclosure. A transparent door closes the otherwise open front wall of the cooking enclosure. This door can be lifted for access to the cooking space or lowered to confine exhaust gases and cooking odors to the interior of the cooking space. A flue is provided at the top of the cooking space for venting the exhaust gases and cooking odors.

U.S. Design Patent No. 460,893 discloses a four-sided combination fireplace, grill, smoker, broiler, outdoor oven which includes an adjustable vent on the top.

A cooking apparatus is disclosed in U.S. Pat. No. 6,626,090 for heat circulation and containment when smoking or grilling using electric, gas, or charcoal as the heat source. The base pan design enhances heat containment, and offers a channel design in the bottom of the base pan. A flame disk for even heat distribution is provided and can be used in conjunction with the base pan, and prevents internal food drippings from escaping through the disk. The disk design enhances the heat efficiency, and safeguards against drippings or ashes falling through to the burner or ground. The holes in the disk are raised, and have attached covers strategically placed over the holes to deter drippings or ashes from falling through. A fire pit container is also provided and designed for use with the base pan. The fire pit container supports a heat source such as a gas burner which directs a flame toward the base pan open hole and also toward the underside of a flame disk when a flame disk is suspended above the base pan hole.

A removable burner assembly providing for a gas barbeque grill is disclosed in U.S. Pat. No. 6,705,307. The removable burner assembly has a burner frame having an open bottom and an open top, a burner connected to the burner frame, and a manifold in fluid communication with the burner. The burner frame, with the connected burner, is adapted to be removably mounted as a self-contained subassembly in the housing of the grill.

Each of the smokers disclosed in these references offers certain positive features. However, none of them combines true portability, ease of assembly, adjustability and effective smoking of food.

It is therefore an object of the present invention to provide a smoker device which can be readily compacted and is light weight so that it may be easily carried, for instance by campers, hikers, and backpackers.

It is a further object of the present invention to provide a smoker device which can be readily assembled without the need for accessory tools.

It is a still further object of the present invention to provide a smoker device which is effective in imparting a smoky flavor to food as it is cooked, the degree of smoky flavor being easily adjustable.

### SUMMARY OF THE INVENTION

The present smoker device is effective in imparting a smoky flavor to food as it cooks and is also conveniently portable. The device includes two pairs of opposing vertical panels, each panel having a substantially rectangular shape and having four substantially straight edges, and an attachment structure located on at least one straight edge of each vertical panel for attaching that side edge to a side edge of an adjacent vertical panel. The two pairs of vertical panels cooperate with hot coals or another heat source, when in operation to form a platform having four top edges and to smoke food. The first pair of vertical panels and the second pair of vertical panels are capable of being folded into a substantially planar shape. A lid covers the top edges of the platform. An adjustable vent is located on the surface of the lid, which in its open position permits maximum smoke to exit the smoker device and in its closed position substantially blocks smoke from exiting the smoker device. A means for supporting food during the cooling operation, such as an array of spaced-apart bars, a grid or one of the other structures in the patents identified above (those patents being incorporated by reference), is secured to the inner sides of the first pair of opposing vertical panels and supports food to be cooked.

### DESCRIPTION OF THE DRAWINGS

FIG. 1 is an overhead view of the lid and the cover.

FIG. 2 is a perspective view of the cover.

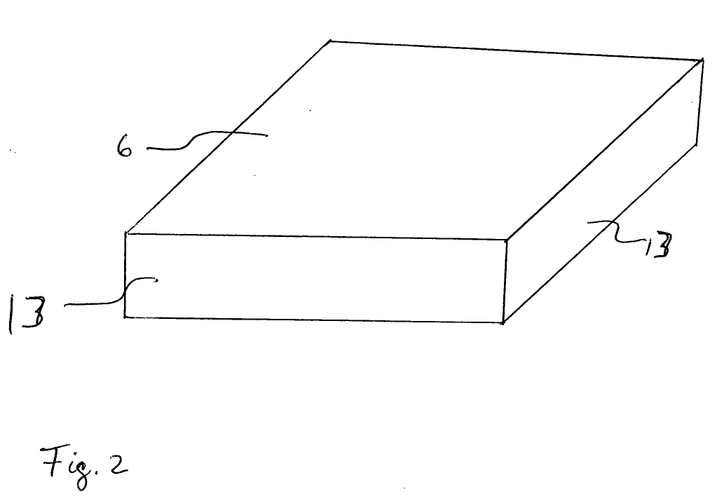

FIG. 3 is an overhead view of the array of spaced-apart bars.

FIG. 4 is an overhead view of the gate.

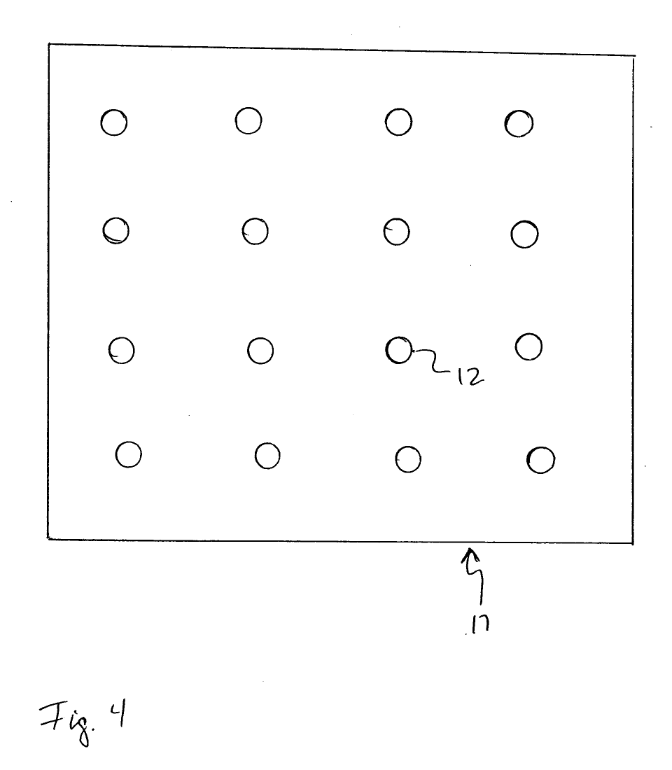

FIG. 5 is a side view of the plurality of vertical panels.

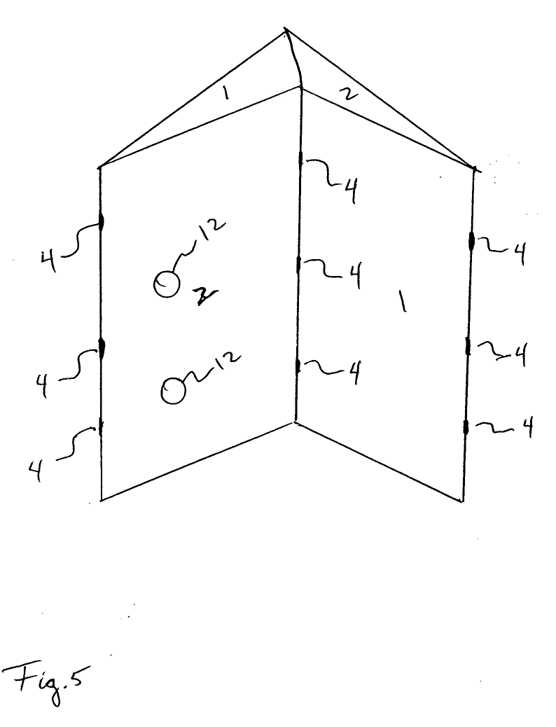

### DETAILED DESCRIPTION OF A PREFERRED EMBODIMENT OF THE INVENTION

The smoker device of the present invention includes a multi-sided platform which may be covered by a lid and used to smoke food as it cooks. The multi-sided platform, when not in use, may be collapsed into a substantially planar form at which time it may be conveniently carried.

The platform includes a first pair of opposing vertical panels 1. Each panel has a substantially rectangular shape and four substantially straight edges 2. The platform also includes a second pair of opposing vertical panels 1, each panel having substantially rectangular shape and having four substantially straight side edges 2. In a preferred embodiment, a handle 22 is attached to one of the plurality of vertical panels 1, more preferably, a handle made of a non-heat-conductive material. Although the present invention preferably has two pairs of opposing vertical panels, it may have additional vertical panels without departing from the spirit of the invention, for instance a third pair of opposing panels or even an additional single panel.

An attaching means 4 is positioned on at least one straight side edge 2 of each vertical panel 1 for attaching that side edge 2 to a side edge 2 of an adjacent vertical panel 1. The first pair of vertical panels 1 and the second pair of vertical panels 1 cooperate to form a platform when in operation to smoke food. When not in use, the first pair of vertical panels 1 and the second pair of vertical panels 1 are capable of folding into a substantially planar shape. The attaching means 4 for joining adjacent vertical panels is preferably one or more hinges, more preferably piano hinges 4.

A lid 5 having a main surface 6 which has at least four lid edges 7 and which simultaneously extends to the four top edges of the platform formed by the first pair of vertical panels 1 and the second pair of vertical panels 1.

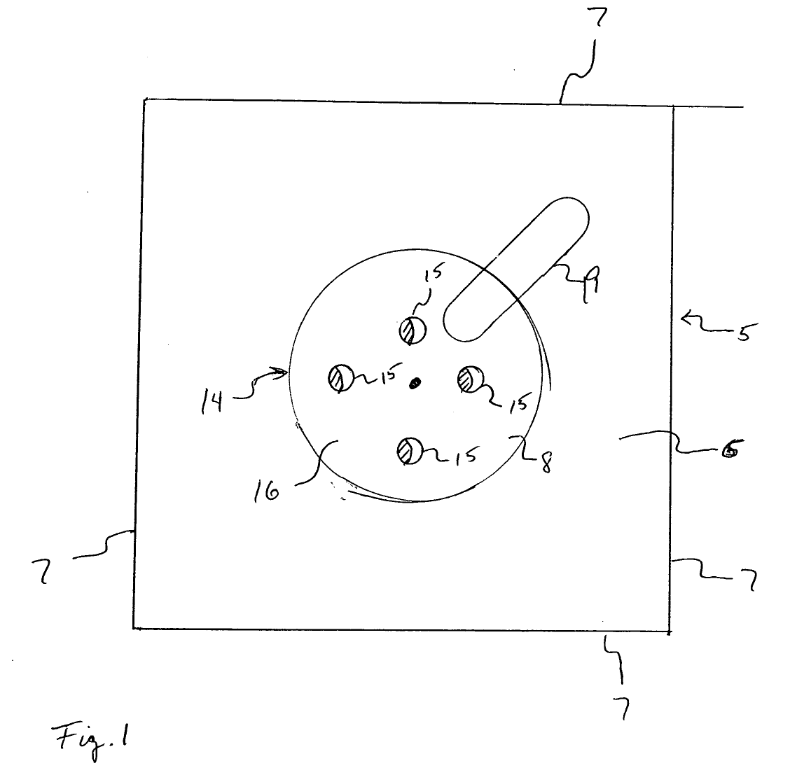

An adjustable vent 8 is positioned in the main surface of the lid 6. In its open position the vent 8 permits maximum smoke to exit the smoker device and in its closed position the vent 8 substantially blocks smoke from exiting the smoker device. There is also a means 9 for alternatively opening and closing the vent, as shown FIG. 1. This opening and closing means 9 may be a tab, a hook or grip which permits the user to adjust the open/closed portion of the holes 15.

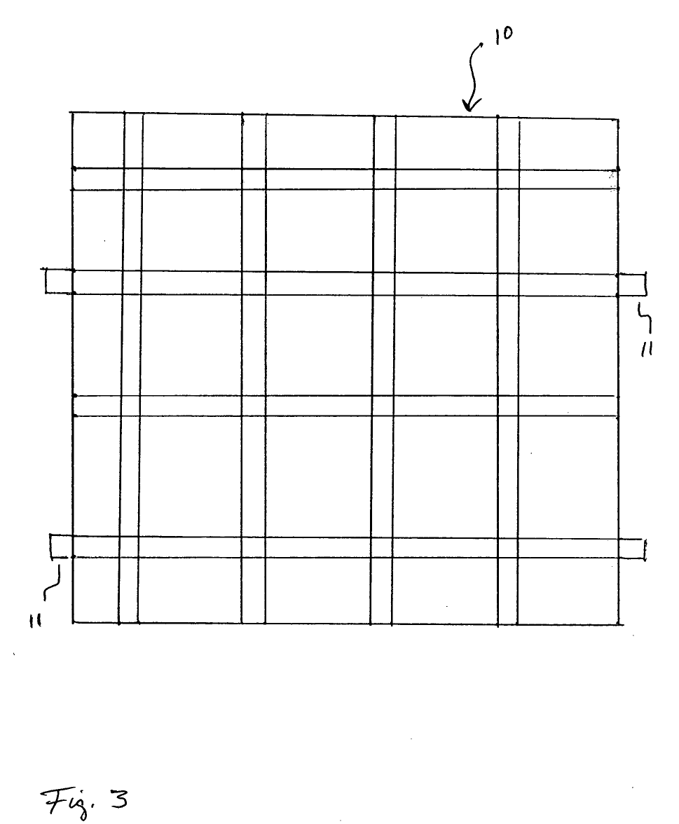

Within the platform and capable of supporting the food to be cooked above a heat source is an array of spaced-apart bars 10 or a grid, attached to which is a means for securing the array to the inner sides of the first pair of opposing vertical panels. In a preferred embodiment, the array of spaced-apart bars 10 is substantially planar and the means attached to the array of spaced-apart bars for securing the array to the inner sides of the first pair of opposing vertical panels, includes projections 11 which extend from the plane of the array 10 and engage corresponding holes or cavities 12 on the insider surface of one or more vertical panels 1 to support the array within the platform formed by the plurality of vertical panels 1. These projections 11 are shown in FIG. 3. In some embodiments, the vertical panels contain multiple sets of holes 12 for receiving the projections 11, so that the array of spaced-apart bars or grid and therefore the food to be cooked may be set at different levels above the heat source.

In a preferred embodiment of the present invention, the means for attaching the edges of adjacent vertical panels 1 is a set of one or more hinges 4, more preferably at least three hinges 4 per join of adjacent vertical panels, most preferably five hinges 4 per join of adjacent vertical panels. The first and second pairs of opposing vertical panels 1 are preferably made of metal, for instance, aluminum or stainless steel.

The lid of the smoker device of the present invention may preferably include skirt panels 13 which in operation extend downwardly from the lid edges of the lid. In a more preferred embodiment, the invention includes an adjustable vent 14 which is formed by a plurality of holes 15 in the lid, and a shiftable cover 16 rotably fixed to the lid. As one skilled in the art will appreciate from FIG. 1, the shiftable cover comprises holes which are in complete registration with the holes in the lid when the vent is in its open position. The shiftable cover 16 is rotably fixed to the lid 5 by a bar 19 which extends across the shiftable cover 16 and which is fixed to the lid 5 by a metal tab joined by the lid by one or more pop rivets.

The smoker device of the present invention preferably includes a grating 17 which is removably attached to the inner sides of either of the first or second pair of opposing vertical panels 1 in a position below the array of spaced-apart bars 10. In a more preferred embodiment, the grating 17 comprises a plurality of small holes and is capable of supporting a cooking material selected from the group consisting of wood and charcoal. However, as those skilled in the art will appreciate, there are many other suitable heat sources which may be used in cooperation with the smoker device of the present invention.

To promote portability, the smoker device of the present invention may preferably comprise a means 18 attached to one of the panels for engaging the lid and the grill when the smoker device is being carried. The means 18 is preferably a hook.

In a preferred embodiment of the present invention a thermometer is attached to the vertical panels or the lid.

The smoker device of the present invention may also include certain etched patterns which perform a useful function. For instance, either the outer surface of one of the vertical panels or the outer surface of the lid and the cover bear a grid pattern forming eight rows and eight columns of squares, to form a checker or chess board when supported by the platform. Also, the lid 5 or the shiftable cover 16 may bear direction symbols for North, South and West or the twelve symbols of the Zodiac. Further, either the outer surface of one of the vertical panels or the outer surface of the lid may show cooking instructions, for instance the internal temperature at which various kinds of meat are fully cooked or in the commonly used expressions, “rare, medium and well-done.”

It is preferred in the present invention to have a first hook is attached to one or more of the vertical panels, which hook is capable of engaging a loop on a backpack and thereby securing the vertical panel to the backpack, and/or a second hook and a second loop secure the cover to the plurality of vertical panels.

The device of the present invention may be adapted to bake bread as will be appreciated by one skilled in the art, without departing from the spirit thereof.

As an alternative to holes, the inside of the vertical panels 1 may be modified with slots to facilitate insertion of the granting and the support means into the area between the vertical walls 1.

1. A smoker device comprising:
a first pair of opposing vertical panels, each panel having substantially rectangular shape and having four substantially straight edges,
a second pair of opposing vertical panels, each panel having substantially rectangular shape and having four substantially straight side edges,
a means located on at least one straight side edge of each vertical panel for attaching that side edge to a side edge of an adjacent vertical panel, wherein the first pair of vertical panels and the second pair of vertical panels cooperate, when in operation to smoke food, to form a platform having four top edges, and wherein the first pair of vertical panels and the second pair of vertical panels are capable of folding into a substantially planar shape,
a lid having a main surface which has at least four lid edges and which simultaneously extends to the four top edges of the platform,
an adjustable vent in the main surface of the lid, which vent in its open position permits maximum smoke to exit the smoker device and in its closed position substantially blocks smoke from exiting the smoker device,
a means for alternatively opening and closing the vent,
a means for supporting food to be cooked, and
a means attached to the means for supporting food to be cooked, for securing the array to the inner sides of the first pair of opposing vertical panels.

2. The smoker device of claim 1, wherein the means for attaching the edges of adjacent vertical panels comprises one or more hinges.

3. The smoker device of claim 1, wherein the first and second pairs of opposing vertical walls are made of metal.

4. The smoker device of claim 3, wherein the metal is aluminum.

5. The smoker device of claim 1, wherein the lid includes skirt panels which in operation extend downwardly from the lid edges of the cover.

6. The smoker device of claim 1, wherein the adjustable vent comprises a plurality of holes in the lid.

7. The smoker device of claim 6, wherein the adjustable vent further comprises a shiftable cover rotably fixed to the lid.

8. The smoker device of claim 7, wherein the shiftable cover comprises holes which are in complete registration with the holes in the lid when the vent is in its open position.

9. The smoker device of claim 1, further comprising a grating which is removably attached to the inner sides of either the first or second pair of opposing vertical panels in a position below the grill.

10. The smoker device of claim 9, wherein the grating comprises a plurality of small holes and is capable of supporting a cooking material selected from the group consisting of wood and charcoal.

11. The smoker device of claim 1, further comprising a means attached to one of the panels for engaging the lid and the grill when the smoker device is being carried.

12. The smoker device of claim 7, wherein the shiftable cover is rotably fixed to the lid by a bar which extends across the shiftable cover and which is fixed to the lid by a metal tab joined by the lid by one or more pop rivets.

13. The smoker device of claim 1, wherein the means attached to the array of spaced-apart bars for securing the array to the inner sides of the first pair of opposing vertical panels, comprises a plurality of projections which are adapted to fit into holes in one or more of vertical panels.

14. The smoker device of claim 1, wherein the grating comprises a plurality of projections which are adapted to fit into holes in one or more of vertical panels.

15. The smoker device of claim 1, further comprising a third pair of opposing panels.

16. The smoker device of claim 1, wherein each panel of the first pair of opposing vertical panels, comprises at least two rectangular sections which are joined to each other by one or more hinges.

17. The smoker device of claim 1, wherein each panel of the second pair of opposing vertical panels, comprises at least two rectangular sections which are joined to each other by one or more hinges.

18. The smoker device of claim 2, wherein the one or more hinges are one or more piano hinges.

19. The smoker device of claim 16, wherein the one or more hinges are one or more piano hinges.

20. The smoker device of claim 17, wherein the one or more hinges are one or more piano hinges.

21. The smoker device of claim 1, wherein said vertical panels, lid and array of spaced-apart bars device have a total weight of three pounds or less.

22. The smoker device of claim 1, wherein said vertical panels, lid and array of spaced-apart bars device have a total weight of two pounds or less.

23. The smoker device of claim 1, wherein said vertical panels, lid and array of spaced-apart bars device have a total weight of one pound or less.

24. The smoker device of claim 1, wherein the outer surface of the lid and the cover bear a grid pattern forming eight rows and eight columns of squares.

25. The smoker device of claim 1, wherein the outer surface of the lid bears direction symbols for North, East, South and West.

26. The smoker device of claim 1, wherein the outer surface of the shiftable cover bears direction symbols for North, East, South and West.

27. The smoker device of claim 1, wherein the outer surface of the lid bears the twelve symbols of the Zodiac.

28. The smoker device of claim 1, wherein the outer surface of the shiftable cover bears the twelve symbols of the Zodiac.

29. The smoker device of claim 1, wherein a first hook is attached to one or more of the vertical panels, which hook is capable of engaging a loop on a backpack and thereby securing the vertical panel to the backpack.

30. The smoker device of claim 29, wherein a second hook and a second loop secure the cover to the plurality of vertical panels.

31. The smoker device of claim 1, further comprising a handle attached to one or the plurality of vertical panels.

32. The smoker device of claim 1, wherein the handle is made of a non-heat-conductive material.

33. The smoker device of claim 1, wherein the means for supporting food to be cooked is an array of spaced-apart bars.

34. The smoker device of claim 3, wherein the metal is stainless steel.

35. The smoker device of claim 11, wherein the means for engaging the lid and the grill is a hook.

36. The smoker device of claim 1, wherein a thermometer is attached to at least one of the vertical panels.

37. The smoker device of claim 1, wherein a thermometer is attached to the lid.

38. The smoker device of claim 1, further comprising cooking instructions on the lid.

39. The smoker device of claim 1, further comprising cooking instructions on one or more vertical panels.

40. The smoker device of claim 1, further comprising slots within the vertical panels to permit easy insertion of the food supporting means into the area between the vertical panels.
